(19) United States
(12) Patent Application Publication
(10) Pub. No.: US 2004/0044654 A1
(43) Pub. Date: Mar. 4, 2004

(54) Methods for recruiting patients for clinical studies

(76) Inventors: Eric S. Ballenger, Ambler, PA (US); Mark R. Eisenach, Princeton, NJ (US); John F. Hollway, Newtown Square, PA (US)

Correspondence Address: ARNOLD & PORTER, IP DOCKETING DEPARTMENT; RM 1126(b), 555 12TH STREET, N.W., WASHINGTON, DC, 20004-1206, US

(21) Appl. No.: 10/230,378

(22) Filed: Aug. 29, 2002

(51) Int. Cl. G06F 7/00

(52) U.S. Cl. 707/3

(57) ABSTRACT

The present invention is in the field of clinical study participant recruitment, and, more specifically, in the field of clinical study participant recruitment by the identification and solicitation of potential clinical study participants through the comparison of their clinical information with desired clinical study criteria.

### FIELD OF THE INVENTION

The present invention is in the field of clinical study participant recruitment, and, more specifically, in the field of clinical study participant recruitment by the identification and solicitation of potential clinical study participants through the comparison of their clinical information with desired clinical study criteria.

### BACKGROUND

The approval of pharmaceutical drugs for patient use entails a lengthy process that includes, at the later stages, the use of the drugs in clinical studies. As used herein, the term “clinical study” is used interchangeably with the term “clinical trial.” Clinical studies require the participation of patients who have volunteered to use a drug in order to test its safety and/or effectiveness and to determine whether the drug has any side effects that would prohibit its acceptance by a governing regulatory agency.

The demand for clinical study participants, however, typically is greater than the supply of clinical study participants. Many factors contribute to this imbalance, including the difficulty of identifying and recruiting potential participants and, in many countries, the statutory proscription against offering a significant financial incentive to potential participants once they have been identified.

Because financial incentives greater than a statutorily defined, nominal amount cannot be offered to potential participants, efforts to increase participant recruitment have tended to focus on improving methods for identifying potential participants and subsequent recruitment techniques.

There are, however, significant impediments to identifying which members of a given population are likely to fit the criteria of a given clinical study. A significant hurdle exists in obtaining access to the information that could most readily be used to identify potential participants. The most significant limitation on identifying potential clinical study participants is the general unavailability of clinical information to clinical study recruiters. For example, access to medical records, insurance records, laboratory test results, and drug histories is typically restricted by law. Doctors, insurance companies, and pharmacies cannot generally provide client medical information to outside companies. Clinical study recruiters cannot directly use such client medical information to determine whether the client is suitable for a given clinical study and must therefore seek alternative means to identify potential clinical study participants.

Advertising and web sites that provide information on clinical studies to potential participants are two means that have been used to recruit clinical study participants. Although advertising and web site solicitation can alert potential participants to the existence of clinical studies, they require affirmative action on the part of the potential participant, and cannot reach many potential participants. In addition, these recruitment techniques are inefficient because they lack specificity in identifying potential research participants, and therefore, many interested participants are not attractive or eligible candidates.

What is needed in the art are methods for more effectively identifying and recruiting potential participants for clinical studies.

### SUMMARY OF THE INVENTION

The present invention includes and provides a method for recruiting participants for a clinical study, comprising searching a database for potential clinical study participants based on selected clinical study criteria, wherein the database comprises confidential clinical information for the potential clinical study participants and wherein the searching is not performed by an investigator on the investigator's own database, and providing contact information about the clinical study to one or more of the potential clinical study participants.

The present invention includes and provides a method for recruiting participants for a clinical study, comprising searching a pharmacy database for potential clinical study participants based on selected drug criteria, wherein the database comprises confidential drug use history for the potential clinical study participants, and providing contact information for the clinical study to one or more of the potential clinical study participants.

The present invention includes and provides a method for recruiting participants for a clinical study, comprising providing selected clinical study criteria to a party possessing a database, wherein the database comprises confidential clinical information about more than one person, requesting the party possessing a database to search the database based on the selected clinical study criteria for potential clinical study participants, and, requesting the party possessing a database to provide contact information for the clinical study to one or more of the potential clinical study participants.

### BRIEF DESCRIPTION OF THE FIGURES

FIG. 1 is a schematic representation of two embodiments of the present invention.

FIG. 2a is a schematic representation of one embodiment of the present invention.

FIG. 2b is a schematic representation of one embodiment of the present invention.

### DESCRIPTION

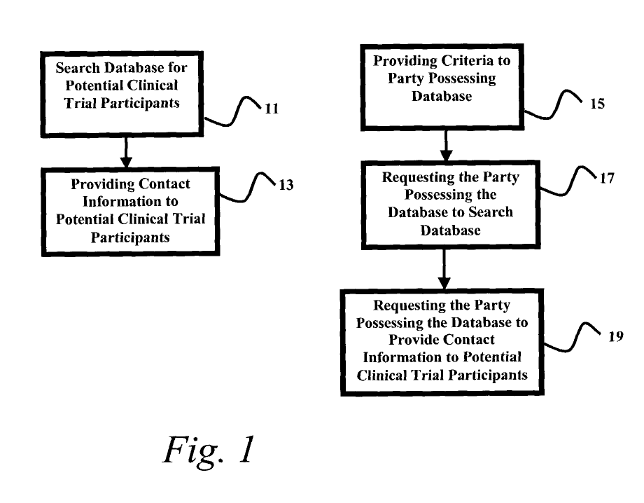

In a preferred embodiment, the present invention provides and includes a method for recruiting participants for a clinical study, comprising searching a database for potential clinical study participants based on selected clinical study criteria, wherein the database comprises confidential clinical information about the potential clinical study participants, and providing contact information for the clinical study to one or more of the potential clinical study participants. FIG. 1 shows this embodiment schematically at 11 and 13. In this embodiment, the searching is not performed by an investigator on the investigator's own database.

In an embodiment of the present invention, a database of information is searched for potential clinical study participants for a particular clinical study. As used herein, a “database” is any organized collection of information that can be searched. The database can be, for example and without limitation, a database residing on a computer that can be searched with software that is capable of automatically parsing records in the database to identify records matching selected search criteria. In this embodiment, a database contains information associated with the clinical information of more than one person. For example, a database can contain the medical history of a group of people who have received treatment at a particular hospital, or a database of the drug histories of a pharmacy's clientele. As used herein, “potential clinical study participants” means the person or group of people in the database who match the selected clinical study criteria. As used herein, “clinical information” includes, but is not limited to, medical records (including inpatient and out-patient), pharmacy data, laboratory data, disease management data, wellness data, insurance claims information (including, but not limited to, diagnostic, laboratory, and procedural), pharmacy claims data, and other information. Clinical information can be located, for example, in hospitals, physician's practices, laboratories, pharmacies, health insurance companies, disease management companies, and/or pharmacy benefit managers (PBMs).

In an embodiment of the present invention, clinical study criteria are used to search a database. Typically, clinical study criteria will be specifically chosen so as to select the best possible candidates for a particular clinical study. As used herein, “selected clinical study criteria” are the desired features of clinical study participants. The selected clinical study criteria can include, for example and without limitation, age, race, gender, disease state, medical history, drug history, geographical information, diagnosis information, and any combination thereof. The searching performed on the database can include the ability to use any Boolean combination of the criteria in order to maximize the size of the pool of potential clinical study participants. Furthermore, searching can result in the return of any information in the database associated with a given record. For example, returned records can include disease state information for a potential clinical study participant as well as information that allows notification of that potential clinical study participant.

In an embodiment of the present invention, the database comprises confidential clinical information. As used herein, “confidential” information means information that cannot be legally divulged by the possessor of the information to unaffiliated clinical study participant recruiting companies or other unaffiliated parties. “Confidential” information includes information that is shared by one company with another company that is obligated to maintain the confidentially of the information. For example, if a pharmacy employs an outside company to perform database searches and that outside company cannot legally divulge the database information to unaffiliated clinical study participant recruiting companies or other unaffiliated parties, then the database information is not removed from the definition of “confidential” by the sharing of that database information with the outside company.

After a database is searched with selected clinical study criteria and one or more individuals have been identified from the database as potential clinical study participants, one or more of the potential clinical study participants are provided with contact information for the clinical study for which the searching was performed. As used herein, “contact information” is any information that allows a potential clinical study participant to obtain information about a clinical study. This notification can occur by any means, including telephonic, mail, facsimile, or email. The notification can include any relevant information, including contact information that the potential clinical study participant can use to contact the supplier of the notification, the investigator running the clinical study, a representative of that investigator, the recruiter, a representative of the recruiter, or a third party. The notification can further include, but is not limited to, any information that is relevant to the clinical study, such as website information, location, duration, and potential benefits or side effects. The notification can be indirect, meaning that a potential clinical study participant may initially be given contact information lacking details about a particular clinical study, and then, after contacting the appropriate entity, the potential clinical study participant will be given the clinical study information. Notification can also be direct, in which case a potential clinical study participant will be given contact information that allows him/her to contact the researcher(s) conducting the clinical study. Notification can be performed by a party possessing the data or a third party who is acting for a party possessing the data.

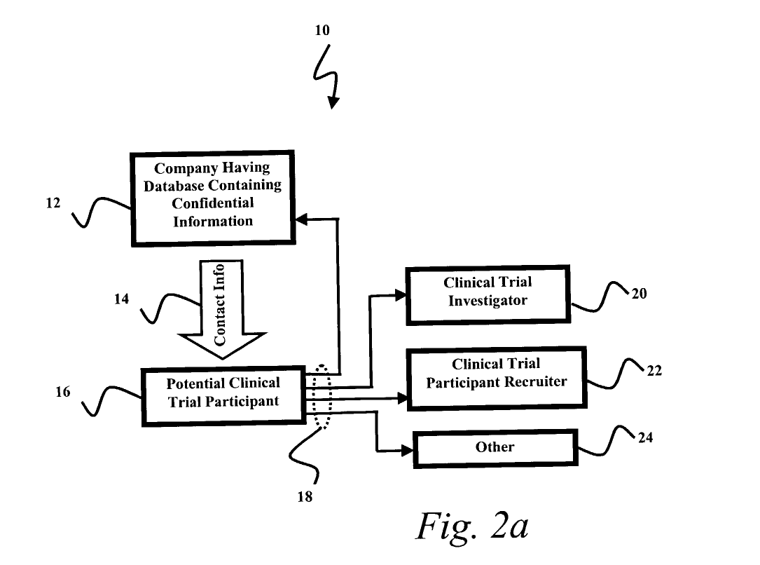

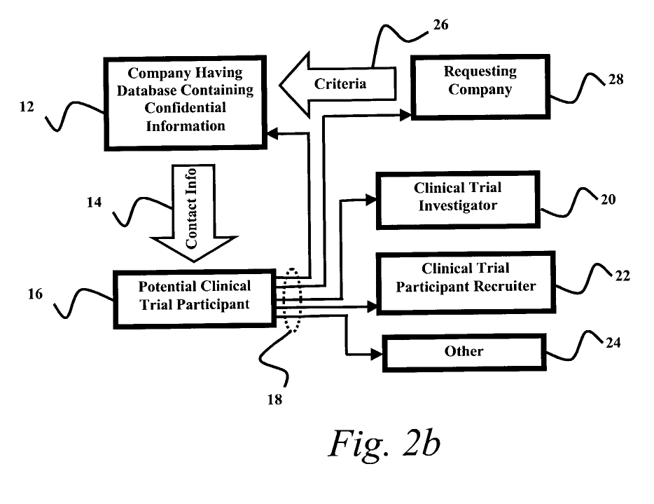

The above-described embodiment is shown generally at 10 in FIG. 2a, which shows a company having a database containing confidential information 12 providing notification 14 to a potential clinical study participant 16, as discussed above. FIG. 2a shows that the potential clinical study participant 16 can be provided with one or more response options 18, including a response to the company 12, the clinical study investigator 20, a clinical study participant recruiter 22, or some other 24 alternative, such as a website URL. In a further embodiment, the notification can be provided to the physician of a potential clinical study participant who can then notify the potential clinical study participant.

In a further embodiment, the present invention includes a method for recruiting participants for a clinical study, comprising searching a pharmacy database for potential clinical study participants based on selected drug use criteria, wherein the database comprises confidential drug history for the potential clinical study participants and, providing contact information for the clinical study to one or more of the potential clinical study participants.

In this embodiment, a pharmacy database is searched for potential clinical study participants. As used herein, a “pharmacy database” is any database containing drug history information from people who have purchased medication through a pharmacy. As above, the database contains confidential information. Searching and providing notification occurs as described above.

In a further embodiment, the present invention includes and provides a method for recruiting participants for a clinical study, comprising providing selected clinical study criteria to a party possessing a database, wherein the database comprises confidential clinical information about more than one person; requesting the party possessing a database to search the database based on the selected clinical study criteria for potential clinical study participants; and, requesting the party possessing a database to provide contact information for the clinical study to one or more of the potential clinical study participants.

This embodiment is shown schematically in FIG. 1 at 15, 17, and 19, and in FIG. 2b. As shown in FIG. 2b, a first company 28 (or requesting company) transfers selected clinical study criteria 26 to another company 12 possessing a database containing confidential information. The first company 28, or requesting company, can be the same entity as the clinical study participant recruiter company or a different entity. In a preferred embodiment, the first company, or requesting company, is a clinical study participant recruiter. As used herein, a “clinical study participant recruiter” is any company that provides the service of matching potential clinical study participants with clinical studies, and can include sponsors and investigators. In this embodiment, the first company 28 requests that the party possessing the database 12 containing confidential information searches the database for members of the database that match the supplied criteria. The first company 28 also requests that the party possessing the database 12 provides contact information about the clinical study to one or more of the potential clinical study participants identified by the search. In this embodiment, the transferring and requesting can be performed simultaneously or in any order.

In this embodiment, the first company 28 can be any company that desires clinical study participants, including, but not limited to, the entity sponsoring the clinical study, the clinical study investigator, and a clinical study participant recruiter. In a preferred embodiment, the first company 28 is a clinical study participant recruiter. As used herein, “providing selected clinical study criteria” means conveying the criteria by any means, including telephonic, electronic, mail, facsimile, and email. As used herein, “requesting” means to ask a party to execute a particular task by any means, including telephonic, electronic, mail, facsimile, and email. “Requesting” includes implied requests. For example, if a company supplies search criteria to a pharmacy which then uses those criteria to perform a search of a database and to notify potential clinical study participants, then requests for searching and providing contact information have been given. The party possessing a database can be, for example and without limitation, an insurance company, a physician's office, an HMO, a laboratory, a pharmacy benefits manager (PBM), a software company, a disease management company, or a pharmacy.

In one embodiment of the present invention, the first company provides an incentive to the potential clinical study participant in the form of a coupon. This incentive can be delivered to the potential clinical study participant by, for example, the company possessing the database, or by the first company, which, in a preferred embodiment, is a clinical study participant recruiter. In a preferred embodiment, the coupon can be redeemed by the potential clinical study participant at the company possessing a database, which, in a preferred embodiment, is a pharmacy. In one embodiment of the present invention, the coupon can be sent to the potential clinical study participant with the initial communication. In a preferred embodiment of the present invention, the coupon can be offered as an incentive to the potential clinical study participant if the potential clinical study participant responds to the initial communication and provides information regarding their interest in participating in the clinical study.

In a further embodiment of the present invention, the first company receives replies from potential clinical study participants who have received contact information.

In another embodiment of the present invention, the company possessing a database can give the first company the results of a search directly. In this embodiment, the first company can then directly contact the potential clinical study participants.

We claim:

1. A method for recruiting participants for a clinical study, comprising:
searching a database for potential clinical study participants based on selected clinical study criteria, wherein said database comprises confidential clinical information for said potential clinical study participants and wherein said searching is not performed by an investigator on said investigator's own database, and
providing contact information about said clinical study to one or more of said potential clinical study participants.

2. The method of claim 1, wherein said database is a pharmacy database.

3. The method of claim 1, wherein said clinical information is information selected from the group consisting of medical records, pharmacy data, laboratory data, disease management, wellness data, insurance claims information, pharmacy claims data, or any combination of the foregoing.

4. The method of claim 1, wherein said searching is performed at the request of an independent entity.

5. The method of claim 1, wherein said contact information includes information directing potential clinical study participants to a screening center.

6. The method of claim 1, further comprising receiving replies from potential clinical study participants.

7. The method of claim 1, wherein said selected clinical study criteria include criteria selected from the group consisting of age, race, gender, disease state, medical history, drug history, geographical information, diagnosis information, and any combination thereof.

8. A method for recruiting participants for a clinical study, comprising:
searching a pharmacy database for potential clinical study participants based on selected drug criteria, wherein said database comprises confidential drug history for said potential clinical study participants; and,
providing contact information for said clinical study to one or more of said potential clinical study participants.

9. The method of claim 8, wherein said searching is performed by a pharmacy representative.

10. The method of claim 8, wherein said searching is performed at the request of an independent entity.

11. The method of claim 8, wherein said contact information includes information regarding or directing potential clinical study participants to a screening center.

12. The method of claim 8, wherein said contact information includes a party requesting said searching.

13. The method of claim 8, further comprising receiving replies from potential clinical study participants.

14. The method of claim 8, wherein said selected drug criteria includes criteria selected from the group consisting of disease, age, geography, gender, prescription drug history, and laboratory results.

15. A method for recruiting participants for a clinical study, comprising:
providing selected clinical study criteria to a party possessing a database, wherein said database comprises confidential clinical information about more than one person;
requesting said party possessing a database to search said database based on said selected clinical study criteria for potential clinical study participants; and,
requesting said party possessing a database to provide contact information for said clinical study to one or more of said potential clinical study participants.

16. The method of claim 15, further comprising receiving information from said potential clinical study participants.

17. The method of claim 15, further comprising receiving information from said party possessing a database, wherein said party possessing a database receives said information directly from said potential clinical study participants.

18. The method of claim 15, further comprising offering an incentive to said party possessing a database.

19. The method of claim 18, wherein said incentive is a coupon.

20. The method of claim 15, wherein said party possessing a database is selected from the group consisting of an insurance company, a physician's office, a health management organization, a laboratory, a pharmacy benefits manager, a software company, a disease management company, or a pharmacy.

21. The method of claim 15, wherein said method is performed by a party selected from the group consisting of a clinical study matching service, a clinical study participant recruiter, and a partner of any of the foregoing.

22. The method of claim 15, wherein said clinical study criteria comprise a member selected from the group consisting of disease, age, geography, gender, prescription drug history, and laboratory results.
